(19) United States
(12) Patent Application Publication
(10) Pub. No.: US 2022/0034550 A1
(43) Pub. Date: Feb. 3, 2022

(54) HEATED FLUE SYSTEM AND METHOD TO VENT A CONDENSING BOILER INTO A NONCONDENSING STACK

(71) Applicant: Aerco International, Inc., Blauvelt, NY (US)

(72) Inventors: Gerald A. Fioriti, Rock Tavern, NY (US); Michael Hubbard, Dallas, TX (US); James Dagley, Eatonton, TX (US)

(21) Appl. No.: 17/383,810

(22) Filed: Jul. 23, 2021

Related U.S. Application Data
(60) Provisional application No. 63/057,435, filed on Jul. 28, 2020.

(51) Int. Cl. F24H 8/00; F28B 11/00; F28B 9/08; F28B 9/02

(52) U.S. Cl. CPC F24H 8/006; F28B 11/00; F24H 1/445; F28B 9/02; F28B 9/08

(57) ABSTRACT

A heated flue includes a flue section configured to be fluidly coupled to an exhaust outlet of a boiler. At least one heater is mechanically coupled to the flue section to heat an exhaust gas flowing within. A sensor is mechanically coupled to the flue section or disposed within the flue section. The sensor is configured to measure a parameter of the exhaust gas flowing within. A controller is operatively coupled to the at least one heater and the sensor. The controller is configured to control a temperature of the exhaust gas based on the parameter. A method to vent a condensing boiler into a non-condensing rated stack is also described.

### CROSS-REFERENCE TO RELATED APPLICATIONS

This application claims priority to and the benefit of co-pending U.S. provisional patent application Ser. No. 63/057,435, HEATED FLUE SYSTEM AND METHOD TO VENT A CONDENSING BOILER INTO A NONCONDENSING STACK, filed Jul. 28, 2020, which application is incorporated herein by reference in its entirety.

### FIELD OF THE APPLICATION

The application relates to flues, particularly to flues for condensing and non-condensing boilers.

### BACKGROUND

Condensing boilers require a relatively expensive stainless steel stack that is listed by UL as Category IV, based on pressure and corrosion resistance. Older boiler stacks are more typically Category I stacks which are presently unsuitable for use with condensing boilers. Particularly in urban settings where boiler stacks can be two hundred feet high, replacing a category I stack with a category IV stack can cost far more than the new condensing boiler.

### SUMMARY

A heated flue includes a flue section configured to be fluidly coupled to an exhaust outlet of a boiler. At least one heater is mechanically coupled to the flue section to heat an exhaust gas flowing within. A sensor is mechanically coupled to the flue section or disposed within the flue section. The sensor is configured to measure a parameter of the exhaust gas flowing within. A controller is operatively coupled to the at least one heater and the sensor. The controller is configured to control a temperature of the exhaust gas based on the parameter.

The heated flue is configured to allow a condensing boiler to discharge exhaust gases to a Category I stack without causing corrosive failure or a net positive pressure within the flue.

The heated flue heats the exhaust gas flowing within to about 400 degrees F.

The at least one heater can include a gas fired burner. The at least one heater can include an electric heating element.

The sensor can include a temperature sensor. The sensor can include a pressure sensor. The sensor can include a water content sensor. The sensor can include a sound sensor.

The water separator is disposed in an exhaust gas path between the boiler and the at least one heater. The water separator can include a cyclone water separator. The cyclone water separator can include an about cone shaped lower section.

The heated flue can further include an acoustic silencer. The acoustic silencer can include a swirl silencer.

A method to vent a condensing boiler into a non-condensing rated stack includes: providing a stack section which includes a water separator and a flue heater; separating a plurality of water droplets from an exhaust gas of the condensing boiler to remove the plurality of water droplets from the exhaust gas; heating the exhaust gas; and venting a dried heated exhaust gas into the non-condensing rated stack.

The step of heating can include heating the exhaust gas to about 400 degrees F.

The step of separating can include separating the plurality of water droplets from the exhaust gas of the condensing boiler to remove the plurality of water droplets by use of a cyclone vapor separator.

The step of separating can include separating the plurality of water droplets from the exhaust gas of the condensing boiler to remove the plurality of water droplets by use of a cyclone vapor separator having an about cone shaped lower section.

The method can further include between the steps of heating and venting, a step of acoustic attenuation by use of a swirl mixing silencer.

A heated flue for venting a condensing boiler into a non-condensing rated stack includes a flue section configured to be fluidly coupled to an exhaust outlet of a boiler. At least one heater is mechanically coupled to the flue section to heat an exhaust gas flowing within. A water separator is disposed at an inlet of the flue section before the at least one heater. A sensor is mechanically coupled to the flue section or disposed within the flue section. The sensor is configured to measure a parameter of the exhaust gas flowing within. A controller is operatively coupled to the at least one heater and the sensor, the controller configured to control a temperature of the exhaust gas based on the parameter.

A cyclone water separator for a boiler exhaust flue includes an input port adapted to accept an exhaust gas including water droplets from the boiler. A cyclone cylinder with a cyclone inducing flow path includes a lower about cone shaped section. An exhaust port is adapted to fluidly couple into a flue section to exhaust the exhaust gas substantially free of water droplets with a particle size over about 0.00025″. A drain drains liquid water from the cyclone cylinder.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1A shows an exemplary electric heated flue according to the Application;

FIG. 1B shows an exemplary gas fuel heated flue according to the Application;

FIG. 2 is a drawing showing a block diagram of an exemplary heated flue according to the Application;

FIG. 3 is a table showing further modeling of an AERCO BMK2000 boiler using a heated flue with water separator venting into a category I stack according to the Application;

FIG. 4 is a drawing showing another block diagram of a heated flue with water separator using a gas fired burner;

FIG. 5A is a drawing showing an exemplary gas fired heated flue 200 with water separator built into an AERCO BMK type boiler 500 as an integral part of the unit;

FIG. 5B is a drawings showing an opposite side view of the boiler with heated flue with water separator of FIG. 5A;

FIG. 6A is a drawing showing a side view of an exemplary simulation of a cyclone water separator with an about cone shaped lower section;

FIG. 6B is a drawing showing a top view of the exemplary simulation of FIG. 6A;

FIG. 7A is a drawing showing a particle study of 0.002″ water droplets for the cyclone water separator of FIG. 6A;

FIG. 7B is a drawing showing a particle study of 0.001″ water droplets for the cyclone water separator of FIG. 6A;

FIG. 7C is a drawing showing a particle study of 0.00039″ (10 micron (0.01 mm)) water droplets for the cyclone water separator of FIG. 6A;

FIG. 7D is a drawing showing a particle study of 0.00025″ water droplets for the cyclone water separator of FIG. 6A; and

FIG. 7E is a drawing showing a particle study of 0.0001″ water droplets for the cyclone water separator of FIG. 6A.

### DETAILED DESCRIPTION

As described hereinabove, condensing boilers require a relatively expensive stainless steel stack that is listed by UL as Category IV, based on pressure and corrosion resistance. Older boiler stacks are more typically Category I stacks which are presently unsuitable for use with condensing boilers. Particularly in urban settings where boiler stacks can be two hundred feet high, replacing a category I stack with a category IV stack can cost far more than the new condensing boiler.

Condensing boilers typically heat water for a closed loop water circulation system, such as to heat a building. The condensing boiler burns a fuel such as natural gas which produces heat, and a hot exhaust flue gas which includes carbon dioxide and water. A condensing boiler can operate with a very high efficiency of about 95% efficient when operated into Category IV condensing stack. A condensing stack, which can be several hundred feet high, is typically lined with stainless steel and is sealed as a pressurized system which can be run as a cold flue. The more efficient the condensing boiler operates, the cooler the flue. However, such a pressurized Category IV stack requires an expensive high grade stainless steel.

It is common to install a replacement or upgraded boiler in place of an old existing boiler installation. Many of the older boilers vent their flue gas into a Category I stack. Category I stacks are not sealed and cannot be pressurized. Moreover, the materials of most category I stacks cannot survive the acidity of the water vapor content of the relatively cool exhaust gas of a modern condensing boiler. Also, a Category I stack must maintain a hot stack to achieve the needed draft of upward traveling boiler exhaust gas. Category I stacks typically require a hot flue gas on the order of 400 degrees F. to promote the flow of exhaust gas up through the stack.

One problem is that to replace a Category I stack with a new Category IV stack can cost far more than the boiler, and introduce so much additional cost into a replacement or upgrade project that even though the new boiler is so much more efficient than the old boiler, the net cost of the project with a new Category IV stack cannot realize a cost savings.

What is needed is a system and method to allow a condensing boiler to vent exhaust gas into noncondensing stack, such as a Category I stack.

More than a century ago, relatively small heaters (Bunsen or gas burner (of a simple flame type), GB 106,468 1917), reheating by rerouting exhaust through steam, or adding a small auxiliary burner (GB 11,502, 1915) were used to heat flue gas to reduce corrosion in a stack. However, such systems at the early part of the last century were not capable of modulating the heat input to maintain 400° F.±10° F. under all firing conditions or controlling the heat input to a sensor to minimize the heat losses up the flue. They had to oversize the flue burner to make sure they didn't allow condensing in the flue under start-up or high load conditions. The structures of these GB patents were not optimal and wasted much of the heat gained by the higher efficiency boiler proposed in GB 11,502, 1915. Also, some heating of the flue gas was to facilitate a discharge of an exhaust gas laden with water vapor.

Now, as described hereinbelow, it has been realized that when combined with mechanical water droplet removal, when the exhaust gas of a condensing boiler is heated to about 400° F., a condensing boiler be used with a non-condensing (e.g. Category I) stack, and the overall efficiency of the system can be increased by exploitation of the energy of latent heat from condensing exhaust gas.

A flue system can be directly attached to the exhaust port of a condensing boiler which removes water from the exhaust from the condensing boiler and heats the exhaust gas to 400° F. using electrical heating elements or a modern gas fired burner to achieve a 400° F.±10° F., a temperature control not achievable by the Bunsen burner or gas fire (gas light) technology of that early part of the last century from 1910 to 1917. Moreover, a water separator, such a cyclone water separator, removes condensed water droplets over a wide range of droplet sizes. Preventing water droplets from entering the heated flue section of the device lowers the required energy input to heat the exhaust gases up to the 400° F. target temperature. If droplets are carried in the gas flow from the boiler to heated flue section, they will absorb the latent heat of the phase change from liquid to vapor, reducing the net efficiency of the system.

The purpose of heating stack gas of the prior art was to achieve greater draft, ascendency of the exhaust gas, as well as to evaporate or further vaporize water so that water did not condense out on the inside surface of the stack, causing stack corrosion.

It was realized however, that adding heat to water droplets in the exhaust heat decreases efficiency. It takes far more heat to reach 400° F. by heating exhaust gas with water droplets. Therefore, according to the application, water droplets are first removed, such as by a water separator, before the exhaust gas is heated in the flue.

By use of the new system and method according the Application, it is now possible to operate a condensing boiler into a non-condensing stack without corrosion, with positive updraft, and an increased net efficiency of the boiler system. That is, while still slightly more efficient to operate the same condensing boiler into a pressurized Category IV stack, by use of the new system and method of the Application, operation into a Category I stack is now possible (with water droplet removal combined with exhaust gas heating), and only slightly less efficient than operating into a far more expensive Category IV stack (approximately 2.7% efficiency loss)

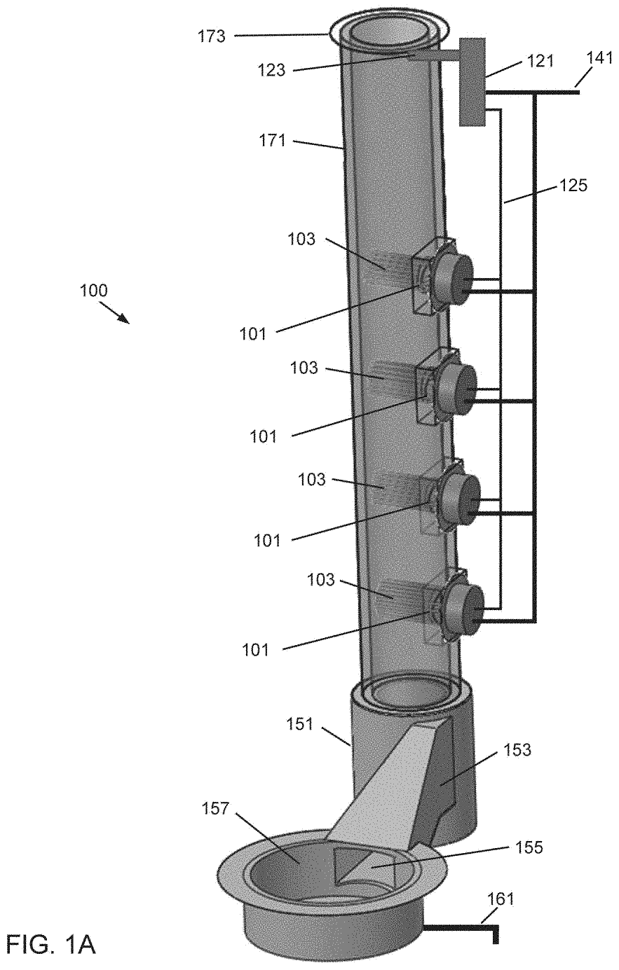

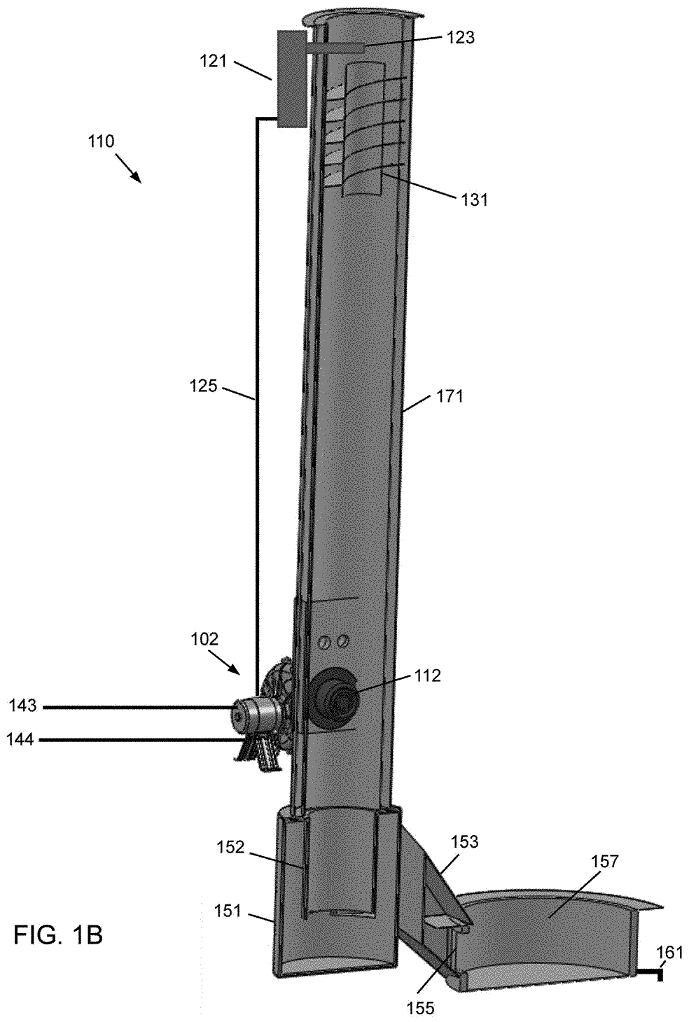

FIG. 1A and FIG. 1B show exemplary electric and gas heated flues with water separators which can be assembled directly to a boiler in place of the conventional flue exhaust pipe. Such a heated flue according to the Application can be added to a condensing boiler with only a small increase in foot print or substantially without any increase in boiler foot print.

FIG. 1A shows an exemplary electric heated flue 100 with water separator which can be assembled directly to a boiler in place of a conventional flue exhaust pipe. The exhaust outlet of a boiler is fluidly coupled (exhaust gas and water droplets) to a cyclone water separator 151. The lower section 157 of the cyclone water separator 151 removes water droplets larger than 7 microns (size) as liquid water which is drained off via drain 161. The exhaust gas from the boiler, now substantially free of water droplets, exits the lower section 157 via passage 155 and vent section 153 into the heated flue 171.

Electric heating elements 103 of electric heaters 101 raise the temperature of the exhaust gas to about 400° F.+/−10° F. A controller 121 regulates the electrical power 141 to electric heaters 101 by any suitable power control method. Suitable power control methods include, for example, on/off operation, proportional control, pulse width modulation, duty cycle control, etc. Controller 121 includes any suitable processor to perform a control loop function, such as, for example, a negative feedback control loop to maintain the temperature of a temperature sensor 123 at about 400° F. Controller 121 can control each or all of the electric heaters via any suitable control line 125, where there is a control input at each electric heater. Or, controller 121 can directly control the electrical power to each or all of the electric heaters by controlling and/or regulating the electrical power delivered to the electric heaters 101 (e.g. a solid state (e.g. one or more SCR) electrical power control in the controller 121. In some cases where controller 121 directly controls the electrical power to each one of the electric heaters separately, or to all in common, the separate control line or control lines 125 can be omitted.

As described hereinabove, exhaust gas exiting the boiler and entering the electric heated flue 100 includes water droplets over a range of droplet sizes. Cyclone water separator 151 removes most or substantially all of the water droplets. Electric heaters 101 then raise the temperature of the relatively cool and now dry exhaust gas entering the heated flue 171 to 400° F., at which point, the now relatively dry and heated flue gas is suitable to be vented into a category I stack. Note that considerable electrical energy savings is achieved by removing the water droplets prior to heating the flue gas. This improvement over the prior art, allows the flue gas to be heated to 400° F. with considerably less energy than would have been required in the prior art, where those systems had to heat the exhaust gas plus the water in the exhaust gas.

FIG. 1B shows an exemplary gas burner heated flue 200 (e.g. natural gas) with water separator which can be assembled directly to a boiler in place of a conventional flue exhaust pipe. The exhaust outlet of a boiler is fluidly coupled (exhaust gas with water droplets) to a cyclone water separator 151. The lower section 157 of the cyclone water separator 151 removes water droplets larger than 7 micron (size) as liquid water which is drained off via drain 161. The exhaust gas from the boiler, now substantially free of water droplets, exits the lower section 157 via passage 155 and vent section 153 into the heated flue 171.

Gas burner 102 raises the temperature of the exhaust gas to about 400° F.+/−10° F. Gas burner 102 can be, for example, a mesh type burner. The fire side 112 of gas burner 102 is shown inside of the flue 171 in FIG. 1B. Controller 121 regulates the gas (e.g. the gas flow rate and/or the air/fuel mixture) by any suitable control method. Suitable control methods include burner on/off operation, proportional control (e.g. fuel/air mixture), burner modulation, duty cycle control, etc. controller 121 includes any suitable processor to perform a control loop function, such as, for example, a negative feedback control loop to maintain a desired temperature of the exhaust gas in the flue based on a parameter measured by a sensor, such as, for example, a temperature sensor 123. The flue gas is optimally heated to about 400° F. The control loop is represented by control line 125.

Where a gas fired burner heats the flue gas in a relatively short length of flue, there can be undesirable sounds including sounds related to burner and flue resonances. A sound silencer can be added to the heated flue section to reduce or substantially eliminate some sounds including resonance related gas burner induced noise. FIG. 1B includes, for example, an optional swirl silencer 131 to reduce stack noise levels.

As described hereinabove, exhaust gas exiting the boiler and entering the gas burner heated flue 100 includes water droplets over a range of droplet sizes. Cyclone water separator 151 removes most or substantially all of the water droplets. Gas burner 102 then raises the temperature of the relatively cool exhaust gas entering the heated flue 171 to 400° F., at which point, the now relatively dry and heated flue gas is suitable to be vented into a category I stack. Note that considerable fuel energy savings is achieved by removing the water droplets prior to heating the flue gas. This improvement over the prior art, allows the flue gas to be heated to 400° F. with considerably less energy than would have been required in the prior art, where those systems had to heat the exhaust gas plus the water in the exhaust gas.

In place of, or in addition to temperature sensor 123, there can also be a pressure sensor (not shown in FIG. 1A, FIG. 1B). Flue pressure can be used to (or is indicative of) the amount of natural draft created in the flue and is directly related to the temperature of the flue gases exiting the flue heating section of this device.

There can also be a moisture or relative humidity sensor. The relative humidity of the flue gases measured after the water droplet separator indicates the effectiveness of the separator. Measured after heating and before exiting to the Category I flue indicates the amount of vapor condensed and separated within the boiler and separator, and that is inversely proportional to the net efficiency of the boiler.

There can also be a sound sensor. The sound sensor can be used to detect thermal acoustic resonance and to make changes in the air/fuel mixture to reduce the sound level.

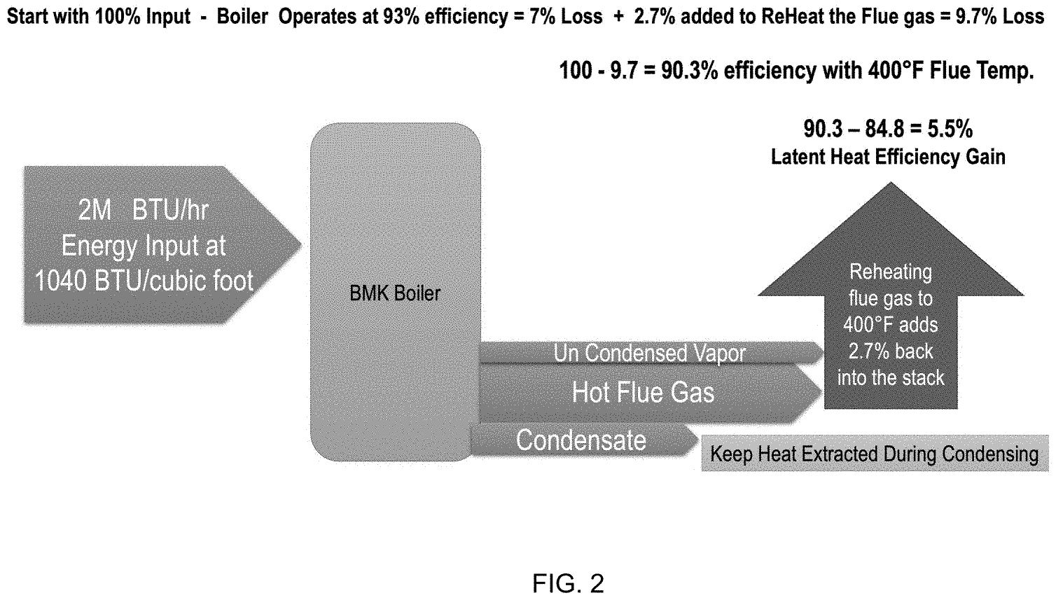

FIG. 2 is a drawing showing a block diagram of an exemplary heated flue according to the Application modeled with a 2 million BTU boiler, such as a BMK industrial type boiler available from AERCO of Blauvelt, N.Y. With reference to a 100% energy input to the BMK boiler in natural gas, the boiler itself, a condensing type boiler, typically operates with an efficiency of about 93% for a 7% loss. Reheating the flue gas adds a 2.7% energy loss (raising the relatively cool condensing boiler exhaust gas (about 240° F. to 400° F.) for a total loss of 9.7%. Note that because of the latent heat gained by condensing the water droplets out of the flue gas stream, only 2.7% energy is used to heat the flue gas to 400° F.

Without the water separator, far more energy would be required to heat the flue gas including the water (about another 5.5%), for an overall lower system efficiency of about 84.8%.

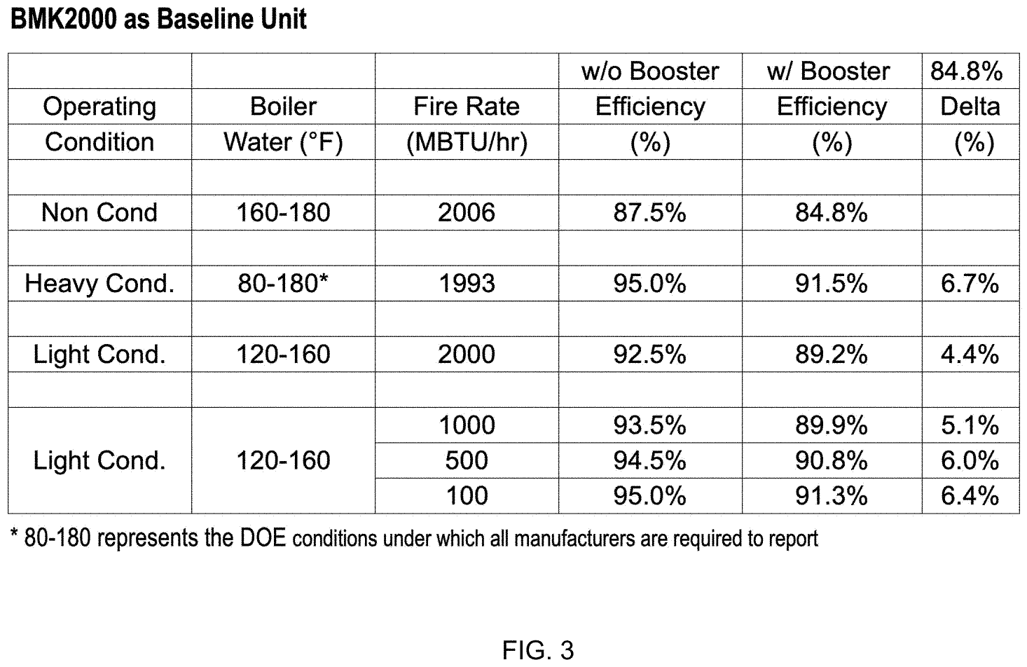

FIG. 3 is a table showing further modeling of an AERCO BMK2000 boiler using a heated flue with water separator venting in a Category I stack according to the Application. Recall that without the new heated flue with water separator of the Application, a BMK2000 boiler would otherwise require a stainless steel Category IV stack. The table of FIG. 3 explores various operating scenarios over a range of inlet water temperatures and outlet water temperatures ranging from a non-condensing operation mode, where the inlet water is a relatively hot 160° F. to a heavy condensing mode where the inlet water is 80° F. Also, light condensing modes of operation are shown over different BMK burner fire rates. In all of the condensing modes of operation, there is a net gain with the new heated flue with water separator of the Application ranging from 4.4% to 6.7% over simply heating the flue without water separation (84.8% as described hereinabove).

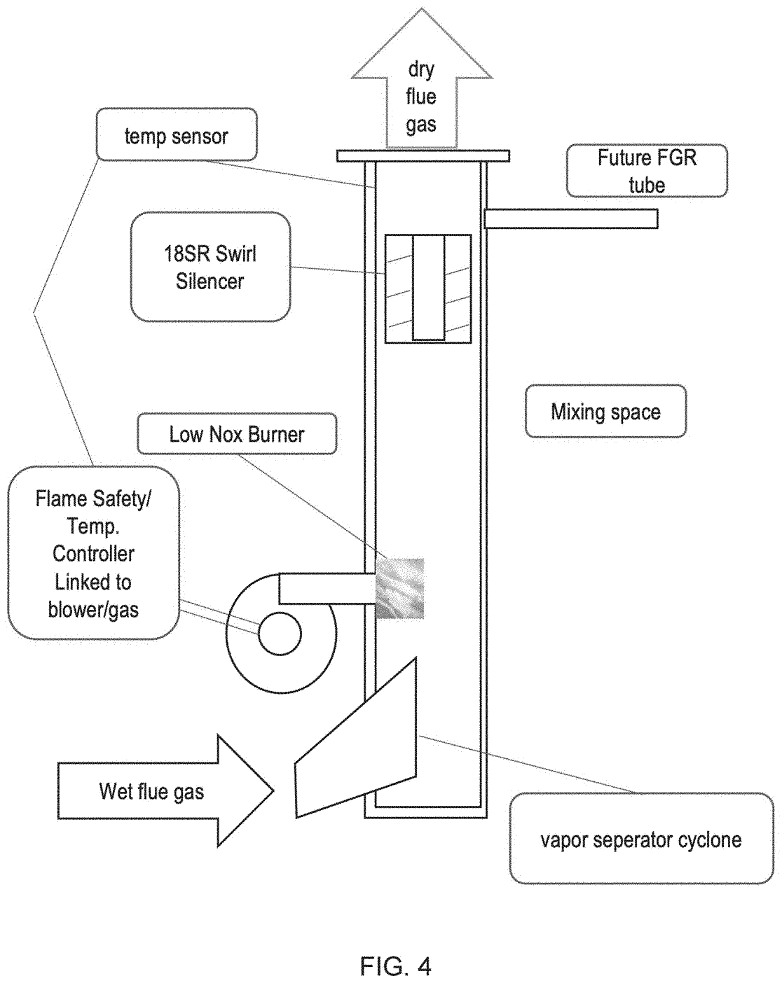

FIG. 4 is a drawing showing another block diagram of a heated flue with water separator according to the Application using a gas fired burner (e.g. FIG. 1B). In the exemplary system of FIG. 4, there is an optional swirl silencer installed in the flue. The swirl silencer reduces or substantially eliminate acoustic resonance modes of a gas fired burner operating into a relatively short length of flue. A swirl silencer can be made, for example, from a type 18SR stainless steel. This exemplary silencer design is intended to create three acoustic paths of different lengths such that the sound waves cause destructive interference instead of resonance.

An optional flue gas return (FGR) tube is also shown in FIG. 4. Because of the water separator, some of the dry reheated flue gas near the outlet end of the flue of the heated flue gas can be returned to the burner of the boiler to reduce NOx emissions into the atmosphere by the stack. Reduction of NOx emission is a goal of all boiler operations as part of clean air requirements and concerns. The relatively dry heated flue gas near the outlet side of the heated flue is well suited for injection into the boiler fuel air mixture to reduce NOx emission. Condensing boilers without this flue heating device or application do not use FGR because the acidic condensate vapor in the flue gases corrodes burner and control valve parts.

Also, shown in FIG. 4, the controller, in addition to regulating the heating of the flue gas, can perform other functions, such as, for example, by adding flame safety and/or over temperature protection features.

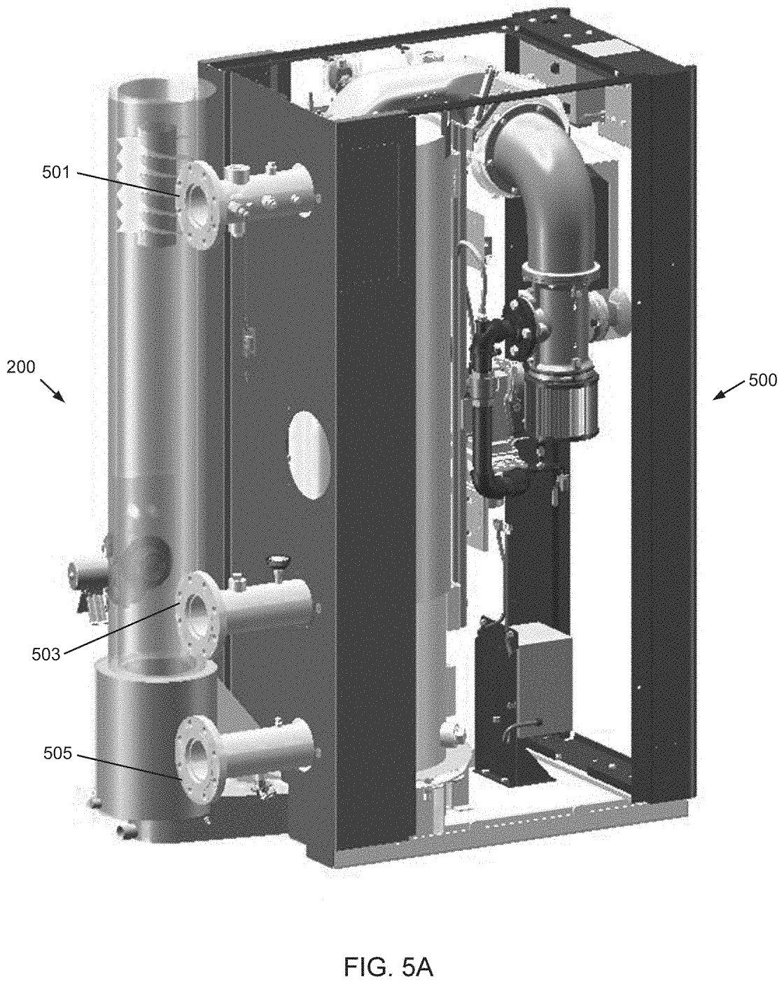

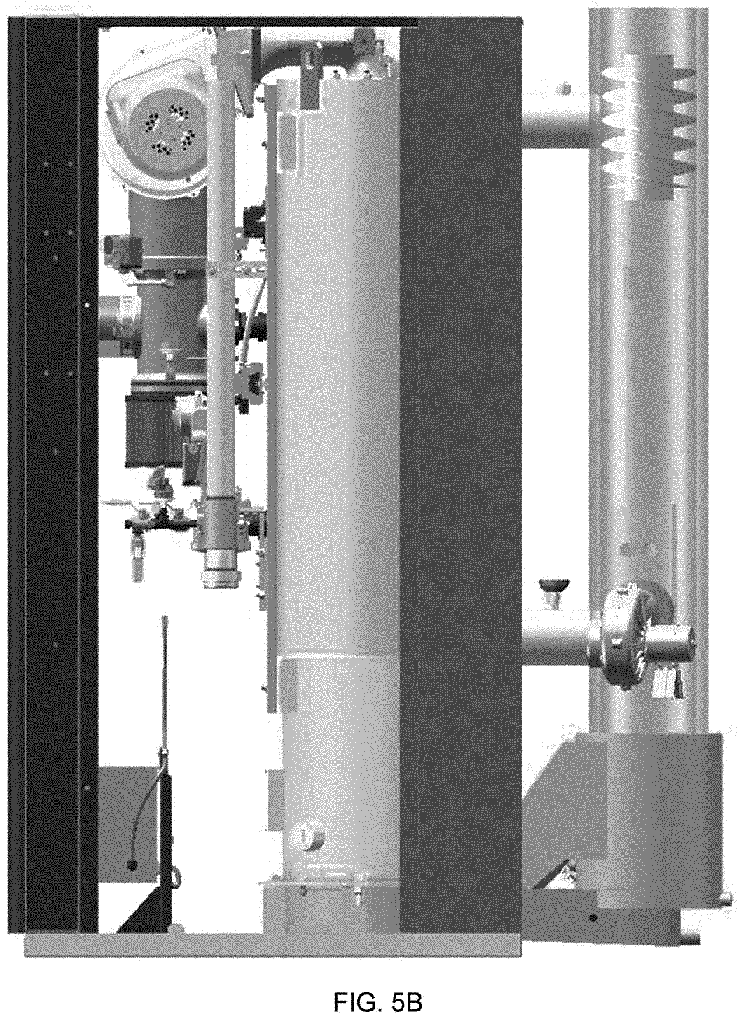

FIG. 5A is a drawing showing an exemplary gas fired heated flue 200 with water separator built into an AERCO BMK type boiler 500 as an integral part of the unit. Boiler 500 is typically used for a closed loop heating application where outlet 500 supplies a heated water. Separate warm water return 503 and cold water return 505 (return water less warm than the warm water at water return 503) contribute to condensing boiler efficiency. FIG. 5B is a drawings showing an opposite side view of the boiler with heated flue with water separator of FIG. 5A.

Cyclone water separator—Exemplary modeling, more specifically with an AERCO BMK2000 boiler was performed. It was realized that cyclone water separator with a lower cone shape, rather than a cylindrical lower section more efficiently removes water droplets over a wide range of droplet size.

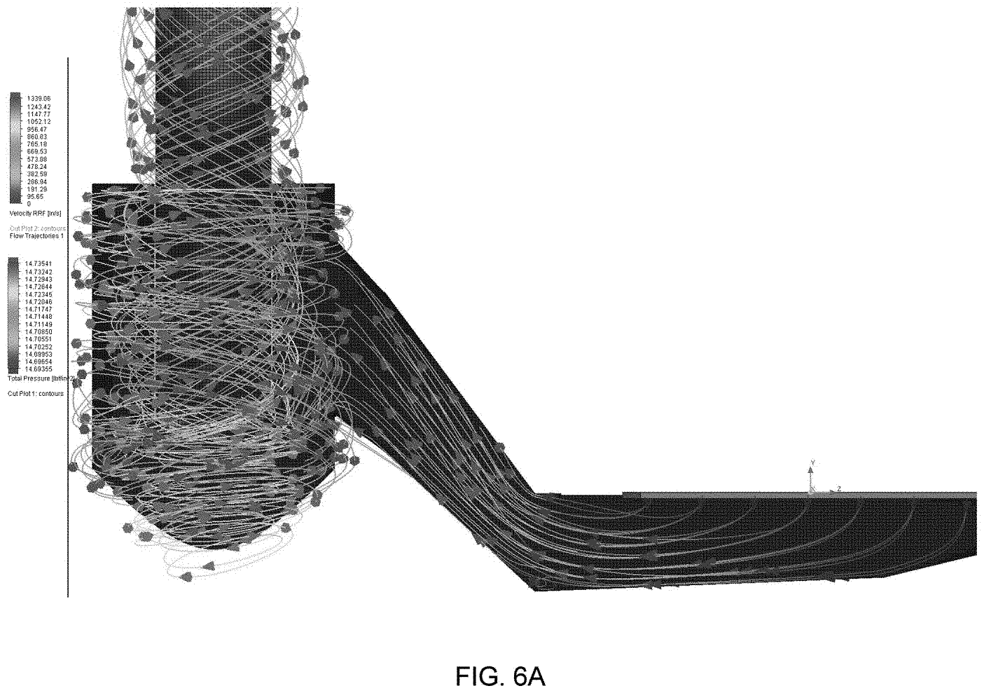

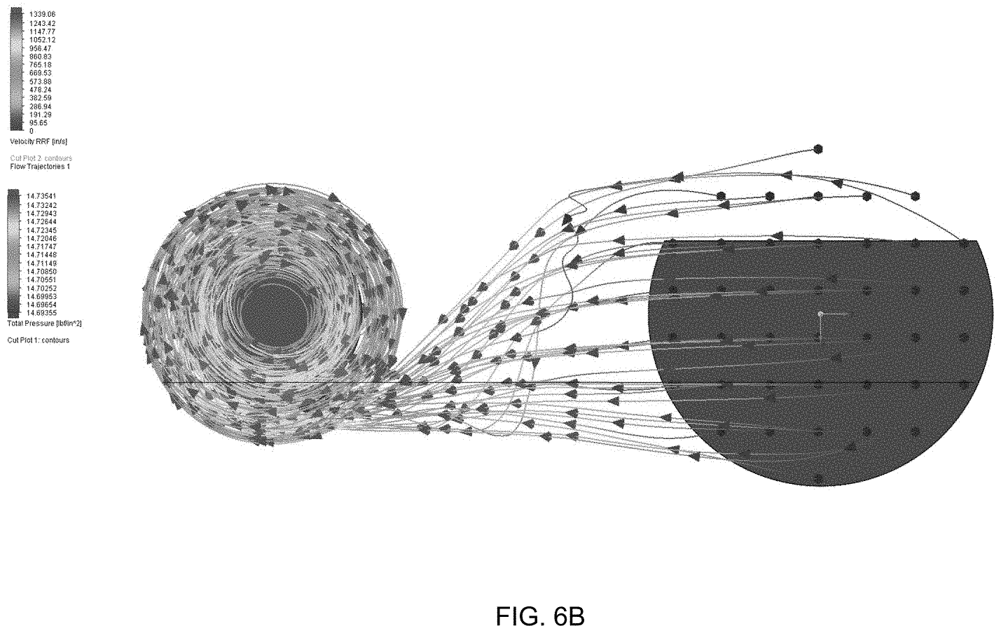

FIG. 6A and FIG. 6B are drawings showing side and top views of an exemplary simulation of a cyclone water separator where the lower cylinder was changed from a cylindrical shape to an about cone shape (here, a cone shape with a rounded bottom, e.g. a frustoconical shape with a rounded cap). FIG. 6A is a drawing showing a side view of an exemplary simulation of a cyclone water separator with about cone shaped lower section. FIG. 6B is a drawing showing a top view of the exemplary simulation of FIG. 6A. In this exemplary simulation of the flow streams, a pressure drop of −0.6 w.c. was realized, which is about half of the pressure drop of earlier simulations where the lower section was cylindrical shaped. The exemplary simulation of FIG. 6A and FIG. 6B is for a full fire operation of the BMK2000 boiler.

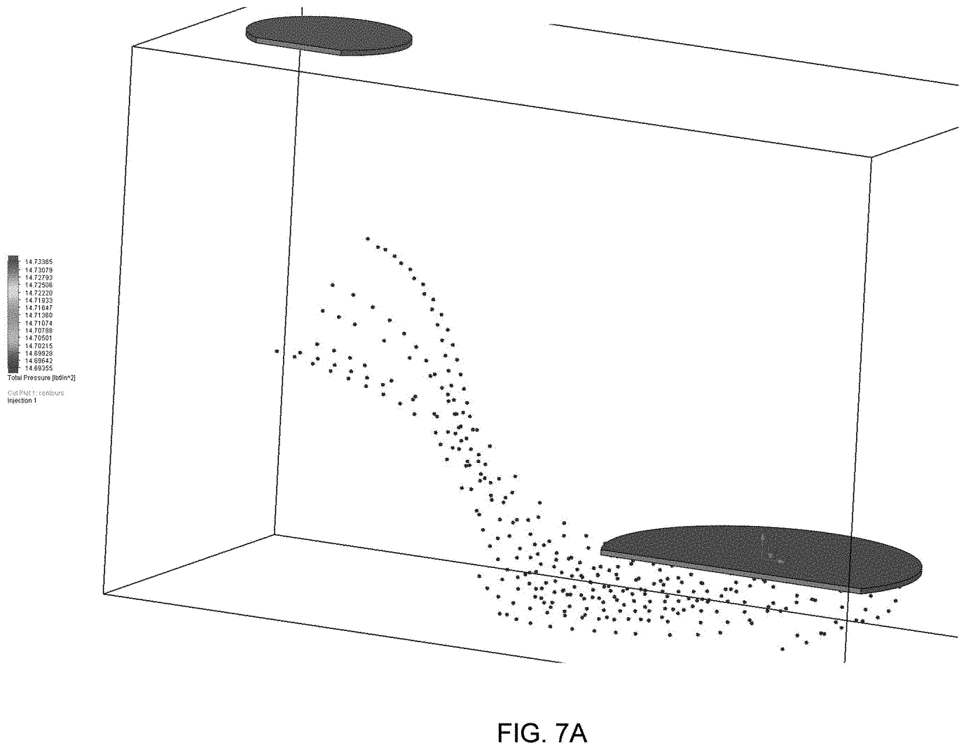

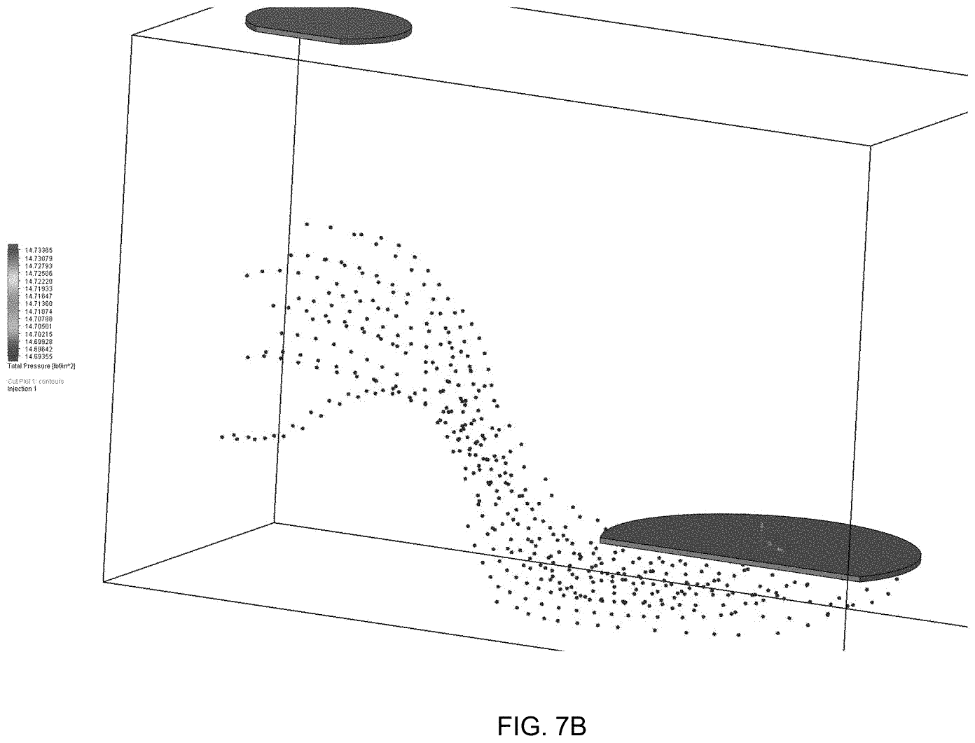

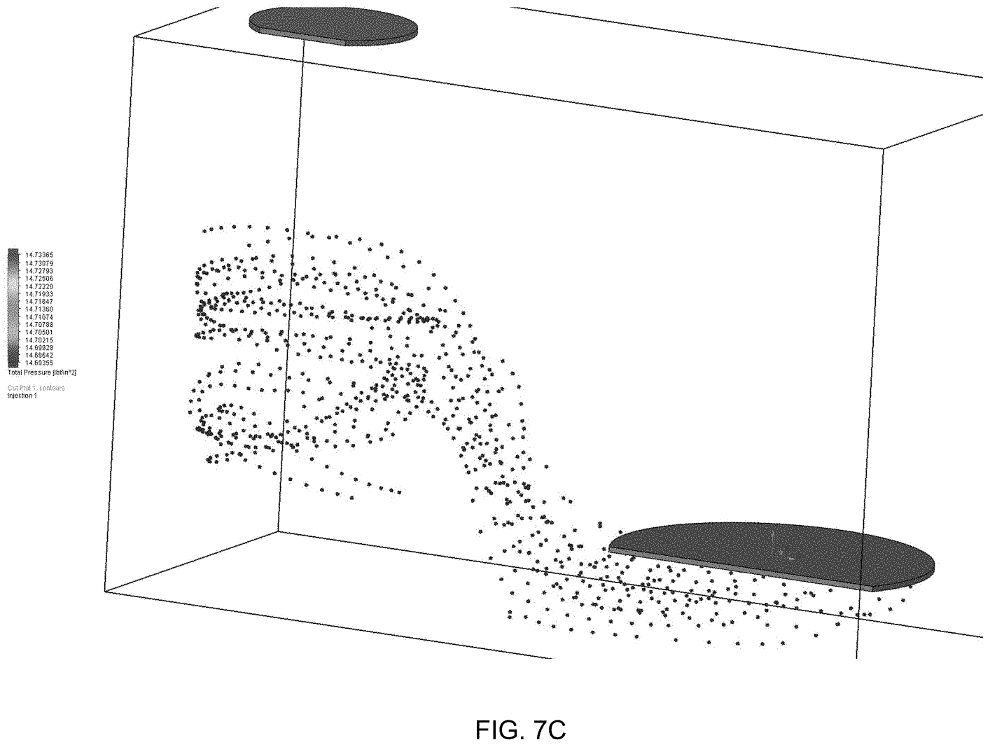

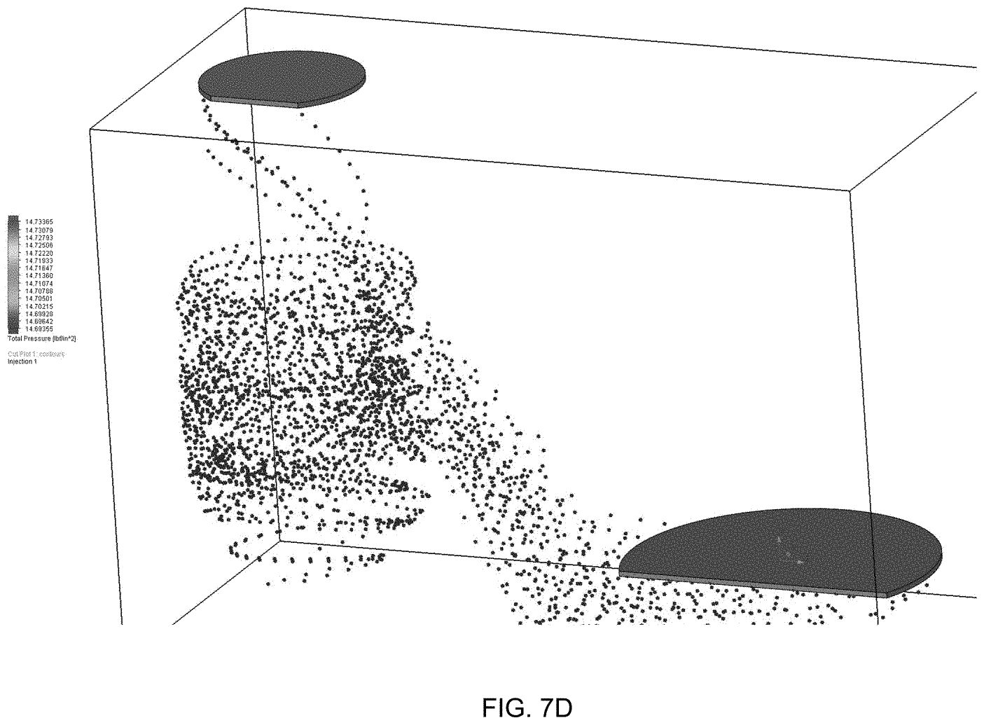

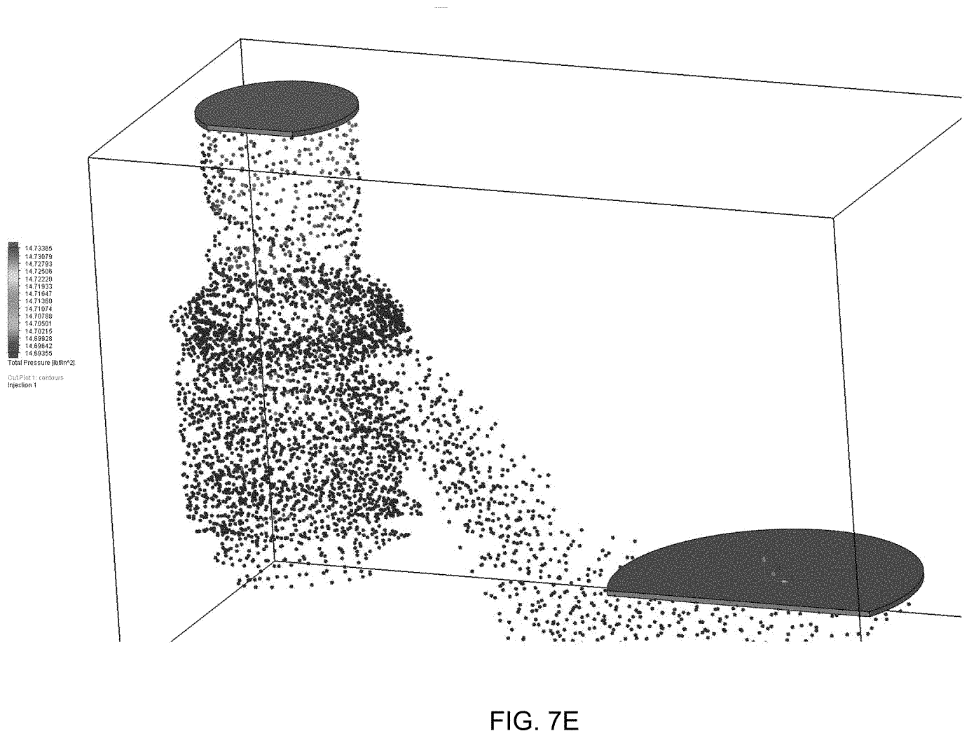

FIG. 7A to FIG. 7E are drawings showing simulations of water droplet flow as particle studies for the exemplary cyclone water separator with a lower about cone shaped section of FIG. 6A. The study was performed over a range of water droplet size, from 0.0039″ to 0.0001″. The wall conditions were set for absorption and accretion of particles. At 0.0039″ (not shown in the drawings) most of the water droplets crashed into the wall while traveling up the ramp to the cyclone.

FIG. 7A is a drawing showing a particle study of 0.002″ water droplets. At 0.002″ the water droplets traveled further into the cyclone.

FIG. 7B is a drawing showing a particle study of 0.001″ water droplets. At 0.001″, some of the water droplets have started to make it around the corner into the tighter vortex of the cyclone water separator.

FIG. 7C is a drawing showing a particle study of 0.00039″ (10 micron (0.01 mm)) water droplets. Now the droplets are fully entrained into the circulating flow pattern of the cyclone, however none are able to escape the vortex, without hitting a wall of either the inner or outer cylinder.

FIG. 7D is a drawing showing a particle study of 0.00025″ water droplets. At 0.00025″, about 4 of 40 of the injected water droplets are able to escape the cyclone to be transported up the flue duct towards the flue burner.

FIG. 7E is a drawing showing a particle study of 0.0001″ water droplets. Now the 0.0001″ size water droplets are of such light weight (low mass) that nearly ½ of the droplets stay entrained in the flow the flue gas and exit the cyclone. For comparison, clouds (weather) form from water droplets in a range from about 1-100 microns, with an average of 10 microns white puffy clouds, similar to the vapor plume from a boiler. Thus, a cyclone water separator with a lower about cone shape can be 100% capable of droplet elimination at a full fire rate for most of the expected range or water droplet sizes.

Controller—Any suitable processor based device can be used as the controller. Suitable processors include, for example, microcomputers, programmed or programmable logic devices, processors, microprocessors, etc. The controller function can also be provided by any suitable computer. Typically, one or more controllers can report performance data, including at least one of temperature, pressure, etc. to one or more computers by any suitable wired or wireless method including, for example, industrial current loops, serial protocols, Bluetooth, WIFI, ethernet, etc. While less common, the controller can also be an analog controller, such as for example, including an analog control and/or analog feedback loop to control the flue heater.

In summary, and with respect to exemplary FIG. 1B, a heated flue 110 for venting a condensing boiler into a non-condensing rated stack includes a flue section 171 configured to be fluidly coupled to an exhaust outlet of a boiler. At least one heater 102 is mechanically coupled to the flue section 171 to heat an exhaust gas flowing within. A water separator 151 is disposed at an inlet of the flue section 171 before the at least one heater 102. A sensor 123 is mechanically coupled to the flue section or disposed within the flue section. The sensor 123 is configured to measure a parameter of the exhaust gas flowing within. A controller 121 is operatively coupled to the at least one heater 102 and the sensor 123, the controller 121 configured to control a temperature of the exhaust gas based on the parameter.

Processor firmware and/or software, including for the controller described hereinabove, design applications and computer modeling, including computational fluid dynamics (CFD) analysis can be provided on a computer readable non-transitory storage medium. A computer readable non-transitory storage medium as non-transitory data storage includes any data stored on any suitable media in a non-fleeting manner Such data storage includes any suitable computer readable non-transitory storage medium, including, but not limited to hard drives, non-volatile RAM, SSD devices, CDs, DVDs, etc.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A heated flue comprising:
a flue section configured to be fluidly coupled to an exhaust outlet of a boiler;
at least one heater mechanically coupled to said flue section to heat an exhaust gas flowing within;
a sensor mechanically coupled to said flue section or disposed within said flue section, said sensor configured to measure a parameter of the exhaust gas flowing within; and
a controller operatively coupled to said at least one heater and said sensor, said controller configured to control a temperature of the exhaust gas based on said parameter.

2. The heated flue of claim 1, wherein said heated flue is configured to allow a condensing boiler to discharge exhaust gases to a category I stack without causing corrosive failure or a net positive pressure within the flue.

3. The heated flue of claim 1, wherein said heated flue heats the exhaust gas to about 400 degrees F.

4. The heated flue of claim 1, wherein said at least one heater comprises a gas fired burner.

5. The heated flue of claim 1, wherein said at least one heater comprises an electric heating element.

6. The heated flue of claim 1, wherein said sensor comprises a temperature sensor.

7. The heated flue of claim 1, wherein said sensor comprises a pressure sensor.

8. The heated flue of claim 1, wherein said sensor comprises a water content sensor.

9. The heated flue of claim 1, wherein said sensor comprises a sound sensor.

10. The heated flue of claim 1, further comprising a water separator disposed in an exhaust gas path between the boiler and said at least one heater.

11. The heated flue of claim 10, wherein said water separator comprises a cyclone water separator.

12. The heated flue of claim 11, wherein said cyclone water separator comprises an about cone shaped lower section.

13. The heated flue of claim 1, further comprising an acoustic silencer.

14. The heated flue of claim 13, wherein said acoustic silencer comprises a swirl silencer.

15. A method to vent a condensing boiler into a non-condensing rated stack comprising:
providing a stack section comprising a water separator and a flue heater;
separating a plurality of water droplets from an exhaust gas of the condensing boiler to remove the plurality of water droplets from the exhaust gas;
heating the exhaust gas; and
venting a dried heated exhaust gas into the non-condensing rated stack.

16. The method of claim 15, wherein the step of heating comprises heating the exhaust gas to about 400 degrees F.

17. The method of claim 15, wherein the step of separating comprises separating the plurality of water droplets from the exhaust gas of the condensing boiler to remove the plurality of water droplets by use of a cyclone vapor separator.

18. The method of claim 15, wherein the step of separating comprises separating the plurality of water droplets from the exhaust gas of the condensing boiler to remove the plurality of water droplets by use of a cyclone vapor separator having an about cone shaped lower section.

19. The method of claim 15, further comprising between the steps of heating and venting, the step of acoustic attenuation by use of a swirl mixing silencer.

20. A heated flue for venting a condensing boiler into a non-condensing rated stack comprising:
a flue section configured to be fluidly coupled to an exhaust outlet of a boiler;
at least one heater mechanically coupled to said flue section to heat an exhaust gas flowing within;
a water separator disposed at an inlet of said flue section before said at least one heater;
a sensor mechanically coupled to said flue section or disposed within said flue section, said sensor configured to measure a parameter of the exhaust gas flowing within; and
a controller operatively coupled to said at least one heater and said sensor, said controller configured to control a temperature of the exhaust gas based on said parameter.

21. A cyclone water separator for a boiler exhaust flue comprising:
an input port adapted to accept an exhaust gas including water droplets from the boiler;
a cyclone cylinder with a cyclone inducing flow path including a lower about cone shaped section;
an exhaust port adapted to fluidly couple into a flue section to exhaust the exhaust gas substantially free of water droplets with a particle size over about 0.00025″; and
a drain to drain liquid water from said cyclone cylinder.
